(19) United States
(12) Patent Application Publication
(10) Pub. No.: US 2019/0061185 A1
(43) Pub. Date: Feb. 28, 2019

(54) IMPROVEMENTS MADE TO THE OPERATING CONCEPT OF A HEAT DEPILATION DEVICE

(71) Applicants: Advaldo de Souza Ferraz Filho, Londrina (BR); Francisco Jacinto de Gois Moura, Sao Jose (BR)

(72) Inventor: Advaldo de Souza Ferraz Filho, Londrina (BR)

(21) Appl. No.: 16/070,398

(22) PCT Filed: Feb. 18, 2016
(86) PCT No.: PCT/BR2016/050034

§ 371 Date: Jul. 16, 2018

(30) Foreign Application Priority Data
Jan. 18, 2016 (BR) BR2020160010344

(51) Int. Cl. B26B 21/48; B26B 21/58; B26B 21/52; B26B 21/40; B26B 19/38

(52) U.S. Cl. CPC B26B 21/48; B26B 21/58; B26B 21/526; B26B 21/522; B26B 19/3846; B26B 21/4062; B26B 19/3873; B26B 19/3886; B26B 21/405

(57) ABSTRACT

A constructive solution where hair removal by thermal dispensing is enabled by the action of accumulators and electric system (4) or by direct supply (6, 7) of electric power converted into thermal power, aiming at the preheating and later heating of a laminar or filamentary conductor (2), upon thermal dispensing by the action of an electrical resistance, conduction by heat transfer, or also conduction or thermal diffusion.

### TECHNICAL FIELD

This utility model concerns the field of cosmetic and personal hygiene technologies, more specifically, depilation or the hair removal close to the skin surface, not fully removing it and not invading hypodermic regions, and keeping preserved the internal portions of the hair follicles.

### INTRODUCTION

The improvements described herein make feasible the hair removal through the dispensing of thermal energy or the conversion of electric power into thermal power by the action of an electrical resistance, conduction through heat transfer or even thermal conduction or diffusion, so that the very device will work as a heat accumulator.

It provides a smooth, comfortable hair removal, carried out by cutting, not by extracting hair, made easier as the thermal dispensing makes epidermis less exposed to the irritability usually caused by depilation or epilation devices provided in the state-of-the-art, where the hair is removed from the root.

The proposed improvements use cutting elements in the form of both blades and filaments, instead of tweezers, which are pre-heated and then heated by the electric current converted into thermal power or by the conduction through heat transfer or even by thermal diffusion.

Preferably made of an active metallic alloy made by fusion, these cutting elements are installed to a holder preferably made of polyethylene or polypropylene, especially the latter, and inert to fluids that may exist on the epidermis.

As such, these improvements enable the instrumentation of the thermal dispensing from a heat accumulation system that when and while connected to a power source, either by the action of embedded accumulators in a previously designed compartment or by direct electric supply promotes the pre-heating and later heating of the cutting elements.

### STATE OF THE ART

Especially for cosmetic purposes, but also for hygienic reasons, society has been perceiving the body hair removal as something needed, for a long time. Hair removal by different means, such as animal blood, fat, turtle carcass, and antimony trisulfide has been reported since at least 1,500 b.c.

Although chemical hair removers are considered a contemporary discovery, this process dates from ancient times, and many other alternatives have been introduced over time.

An example is the hair removal using threads, a technique comprised in the use of a cotton thread, twisted and wound with both hands, so to cause a pressure when slid over the skin, entwining itself to the hair and promoting its extraction from the follicle. This technique is more commonly used for the face, since it does not cause irritations as it is often the case for processes using chemical means, especially for the more sensitive skins.

Wax is another method used, where hair is extracted from the root. It is efficient, but increases risks of inflammations and diseases, especially for the removal of pubic hair, according to a French research published in the journal Sexually Transmitted Infections.

Associated to the wax hair removal, there are other risks, such as folliculitis, a skin inflammation caused by bacteria in people with low immunity and predisposition, because the use of hot wax may burn and hurt, producing injuries that may pave the way for infections.

According to Indiana University, which has interviewed 2,451 women in 2012, in the United States, two thirds of the young people from 18 to 24 years old remove their hair. Although there is no similar research in Brazil, these numbers are possibly higher here, once this country is among the top consumers of cosmetic products and techniques.

Beeswax is also relatively well known, as well as creams with chemical compounds that soften the hair. Although there is virtually no irritation, this method does not remove hair from the root, which makes it easier for new hair to grow faster.

There are many variations of state-of-the-art electric hair removers. They work as extractors and not as a cutting device, removing hair from the root, basically aided by many preferably metallic tweezers, similar to those of a common shaver.

And there are the so-called permanent methods, such as laser hair removal and hair burn by electrolysis, in addition to the most recent pulsed-light hair removal method.

After all, techniques and devices that gather different functions are relatively widespread in the common practice, and the available constructive solutions, in the case of devices and instruments, are countless.

Through state-of-the-art research, as commented below, it was possible to find documents covering several operative conceptions, out of which, excluding those whose operation follows concepts different from that of this report, the following were selected:

Brazilian document BR MU89022262U2, filed on Oct. 6, 2010, under the name SHAVING FOAM HEATER, it is a device intended to heat or keep hot a portion of shaving foam; comprised of a half-sphere-shaped container, assembled on the top of a preferably cylindrically-shaped enclosure, having an electric resistance for heating, a thermostat, and, optionally, a temperature adjustment button.

BRMU89027620U2, filed on Nov. 26, 2006, under the name IMPROVEMENTS INTRODUCED TO THE CONSTRUCTIVE CONCEPTION OF A SHAVING DEVICE, it teaches the constructive solution to which it is installed the regulation of the blades contact angle (1) in relation to the hair, so that the cutting will no longer take place by putting pressure on it, but through the sliding of the blades (1) over the hair (1).

Brazilian document BRMU91009677U2, filed on May 23, 2011, under the name ADAPTER FOR SHAVERS, it is about an adapted cover fixed or fitted to the head of the disposable shaver to provide a predetermined space to the distance between the skin and the blade, producing a standard hair cutting effect at the selected height.

Brazilian document BR PI10014578A2, filed on May 28, 2010, under the name SHAVER SET WITH LIGHTING, SHAVING FOAM, AND AFTER-SHAVE LOTION, FEATURING NANOMETRIC MICROBICIDAL RESOURCES, it describes shavers with led lights emitters on the edges where the blades are positioned, as well as the presence of substances such as nano-structured silver, TiO˜2˜, ZrO˜2˜, Sn0˜2˜, and/or any other substances that, when activated by white, violet, ultraviolet or other lights, coming from the LEDs provided on the brush, produce an effect named heterogeneous photo catalysis effect, which has a high microbicide capacity.

Brazilian document BR PI10063072A2, filed on Dec. 3, 2010, under the name VIBRATORY SHAVER SET WITH LIGHTING, SHAVING FOAM, AND AFTER-SHAVE LOTION, FEATURING NANOMETRIC MICROBICIDAL AND CICATRIZING ADDITIVES, whose object is vibratory shavers and light emitters, shaving foam, and after-shave lotions, stating the employed of nano-technological resources to generate cicatrizing and microbicide effects.

Brazilian document BR MU90014014U2, filed on Dec. 22, 2010, under the name CONSTRUCTIVE DEVICE APPLIED ON A INTEGRATED BLADE DEVICE AND FOAM TUBE comprised of a tube (1) of shaving foam provided with a thread (2) on its upper side, which is interconnected to a body (3) with a mainly trapezoidal shape, provided with an internal thread on one side, while the other side is provided with a cover (4) having a parallelepiped shape that acts as a support for the device (5) with a shaving blade, and a cylinder (6) of foam that is intended to generate foam using the cream on the user's face; moreover, this set cannot be sold separately to the user.

Brazilian document BR MU91027799U2, filed on Sep. 19, 2011, under the name SHAVER WITH A CLEANING DEVICE, it describes a shaver with a cleaning device that gathers cleaning and hygiene functions for the shaving blade on the shaver, which is assembled on a main support (D), either fixed or not, in the handle (F), provided with one or more blades (8); and one or more removing plates (6). The cleaning device is assembled on the posterior side of the main support (D), so not to interfere with the shaving process.

Brazilian document BR 202014000946-4, filed on Jan. 15, 2014, under the name THERMAL SHAVING/HAIR-REMOVING DEVICE, it is a device that gathers in a single appliance both shaving/hair removing functions and the dispensing of thermal power converted by the heating of the common-use conductor supplied with electric power, either by an electric resistance, conduction by heat transfer, or thermal diffusion.

Once exposed the documents concerning state-of-the-art devices, the inference is that all of them are about other concepts than that proposed hereby.

Document BR MU89022262U2 addresses a shaving foam heating device, while documents BR MU89027620U2 and BR MU91009677U2 deal with constructive solutions intended to regulate the contact angle between blades and skin, the former, and the distance between skin and blade, the latter.

Documents BR PI10014578A2 and BR PI10063072A2 improve the integration of the shaving device to a cream and lotion dispenser, and the conjunction with the vibratory function of the device.

On its turn, document BR MU90014014U2 integrates the shaving device to a cream dispenser, while document BR MU91027799U2 describes a shaver conjugated to a blade-cleaning device, comprised of a main support provided with one or more blades and, essentially, spring systems, steps, and creases.

Finally, document BR 202014000946-4, owned by the Applicant, gathers the functions of hair removal and dispensing of thermal energy converted by the heating of a conductor supplied with electric power through an electrical resistance, conduction by heat transfer, or by thermal diffusion, and counts on functions shaving/hair removal, and heat dispensing, upon the use of batteries.

As such, and in view of the listed documents, although they address the conjunction of functions in some of the mentioned cases, they are about other operating concepts than that proposed hereby, except for document BR 202014000946-4, also owned by the Applicant, whose object was precisely improved in the thermal dispensing operation, as it used to be converted by heating of a conductor supplied with electric current or through an electrical resistance, heat conduction or thermal diffusion; while in this report, hair removal is made possible upon the dispensing of thermal energy or the conversion of electric power into thermal power by the action of an electrical resistance, conduction by heat transfer, or thermal conduction or diffusion, so that the device will work as an accumulator, either by the action of accumulators or the direct power supply, when a conductor, either filamentary or laminar, is heated by the electric current converted into thermal power.

### SUMMARY OF THE OBJECT OF THE INVENTION

The object of this report comprehends constructive improvements that make possible hair removal by dispensing of thermal energy or the conversion of electric power into thermal power by the action of an electrical resistance, conduction by heat transfer or thermal conduction or diffusion, so that the very device will work as a heat accumulator, either by the action of accumulators or by the direct supply of electric power converted into thermal power, aiming at the preheating and later heating of the laminar or filamentary conductor.

Moreover, the conduction means where the element for cutting hair near the skin is supported, is proposed in the form of either strands or blades.

### DESCRIPTION OF THE DRAWINGS

The characterization of the reported improvements is made using drawings that represent the proposed solution, so that the operating concept is clearly understood.

The figures express the preferred forms to realize the conceived product, and back this description through numerical and consecutive remissions that clarify functional aspects that may be presumed by the description, then precisely defining this application.

FIG. 1, while addressing the preferred constructive solution, shows the anatomic handle (3) where the electric and power accumulation system (4) is embedded, as well as the (5) supply base, and the support (1) of the cutting sector with strands (2).

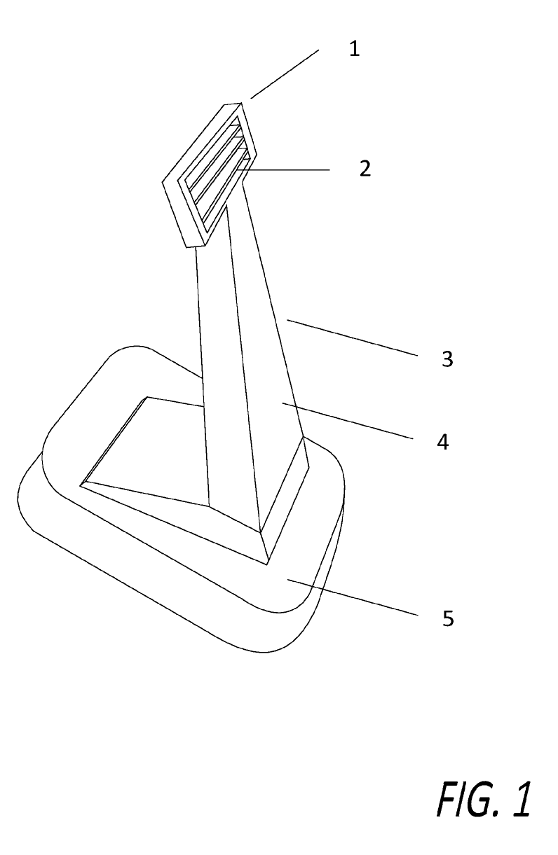

FIG. 2, representing a second constructive alternative, describes the cutting sector (1) with blades (2).

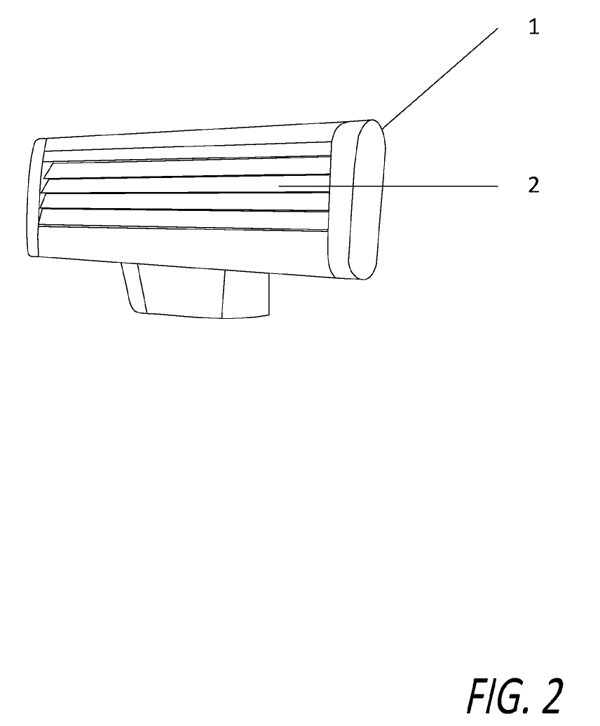

FIG. 3 represents a constructive alternative where the device has no (5) supply base, then replaced with a cable (6) and switch (7) for direct power supply.

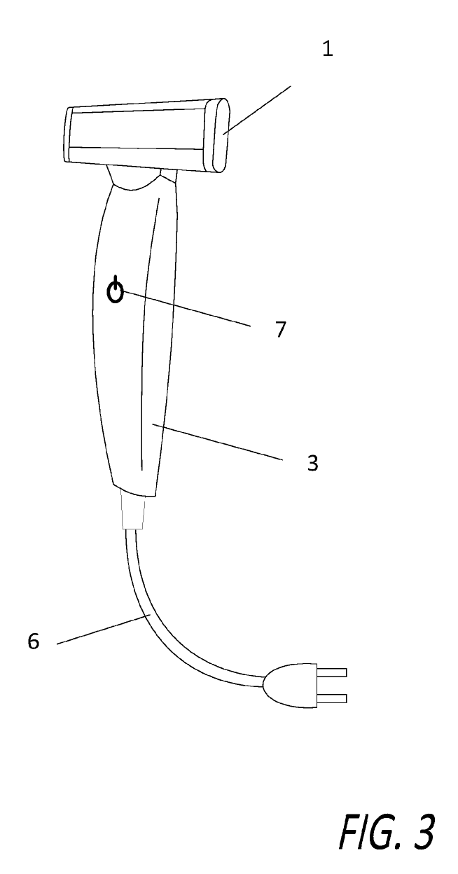

### DETAILED DESCRIPTION OF THE OBJECT OF THE INVENTION

Considering the pertinent remarks on the state-of-the-art devices above, the object of this descriptive report is a constructive solution that, when applied to a thermal-dispensing hair removal device, is enough for the electric power conversion into thermal power to be achieved through the action of accumulators or by direct power supply, when a conductor is heated by the electric current converted into thermal power.

Constructively, the object of this report is instrumented by filamentary and laminar conductors made of active alloy preferably comprehending, at least, zinc, copper, and manganese, and prepared by fusion, so that they can preheat and then heat, even by conduction, either by the action of accumulators or by an electric current converted into thermal power.

Also concerning instrumental aspects, the very device is comprised of a support where seats the cutting sector, either laminate or filamentary, preferably molded in a selected plastic from the group of polyethylene and polypropylene or a substitute, especially the latter, and inert in relation to fluids that may be found on the epidermis.

1- IMPROVEMENTS MADE TO THE OPERATING CONCEPT OF A HEAT DEPILATION DEVICE, which comprehends an electric and power accumulation system (4) embedded in an anatomic handle (3) provided with a support (1) for the cutting sector (2), either connected or not to a supply (5) base, characterized by the fact that the cutting elements (2) are heated by dispensing thermal power or the conversion to electric power into thermal power by the action of an electric resistance, conduction by heat transfer or also, thermal conduction or diffusion, turning the very device into a heat accumulator, either by the action of accumulators and the electric system (4) of common use embedded to the anatomic cable (3) or by direct power supply (6, 7).

2- IMPROVEMENTS MADE TO THE OPERATING CONCEPT OF A HEAT DEPILATION DEVICE, according to claim 1, characterized by the fact that the cutting elements (2) are made of active metallic alloy produced by fusion and installed to the support (1), to be presented in the form of both strands and blades.

3- IMPROVEMENTS MADE TO THE OPERATING CONCEPT OF A HEAT DEPILATION DEVICE, according to claim 1, characterized by the fact that the supply base (5) may be replaced with a cable (6) and an on/off switch (7) for direct power supply.
